(19) United States
(12) Patent Application Publication
(10) Pub. No.: US 2023/0170970 A1
(43) Pub. Date: Jun. 1, 2023

(54) CONTROL APPARATUS, CONTROL METHOD AND RECODING MEDIUM

(71) Applicant: NEC Corporation, Tokyo (JP)

(72) Inventors: Jun SHIKIDA, Tokyo (JP); Kazushi MURAOKA, Tokyo (JP); Toshiki TAKEUCHI, Tokyo (JP)

(73) Assignee: NEC Corporation, Tokyo (JP)

(21) Appl. No.: 17/992,365

(22) Filed: Nov. 22, 2022

(30) Foreign Application Priority Data
Dec. 1, 2021 (JP) 2021-195676

(51) Int. Cl. H04B 7/06; H04B 17/309

(52) U.S. Cl. CPC H04B 7/0695; H04B 17/309

(57) ABSTRACT

Provided is a control apparatus configured to acquire a measurement result including information on reception qualities of a plurality of beams, update a database including information representing a relationship between the plurality of beams for each of a plurality of propagation environments, based on the measurement result, and perform selection processing for selecting a beam using the database.

### CROSS-REFERENCES TO RELATED APPLICATION

The present application claims priority to Japanese patent application No. JP 2021-195676 filed on Dec. 1, 2021, the content of which is hereby incorporated by reference in its entirety.

### BACKGROUND

### Technical Field

The present disclosure relates to a control apparatus, a control method and a recording medium.

### Background Art

A mobile communication system in 5th Generation (5G) supports high frequency bands such as millimeter wave bands. Since the propagation loss is large in the high frequency band, beamforming techniques may be used to compensate for the propagation loss. Beamforming is control for controlling the phase and amplitude of radio signals transmitted or received by a plurality of antenna elements to change the shape and direction (angle) of a beam.

Hereinafter, a combination (synthesis) of radio waves (signals) transmitted or received by a plurality of antenna elements is referred to as “beam”. More specifically, a beam obtained by combining signals transmitted by the plurality of antenna elements is referred to as “transmitting beam”. A beam obtained by combining signals received by the plurality of antenna elements is referred to as “receiving beam”.

Since an area covered by a single beam is limited, a mobile communication system may use a plurality of beams to ensure a coverage area in a high frequency band. PL 1 and PL 2 disclose a base station configured to use a plurality of beams. PL 3 discloses a base station configured to select, from a plurality of beam candidates, a transmitting beam for transmission to a terminal apparatus. NPL 1 discloses a technique for selecting a user (terminal apparatus) to be communicated with.

[PL 1] JP 2020-523872 A

[PL 2] WO 2019/155578

[PL 3] WO 2018/128048

[NPL 1] Uchida et al., “Distributed Antenna Systems using High-frequency-Band for 6G Wireless Networks”, IEICE Technical Report, NS2020-101, RCS2020-148(2020-12).

### SUMMARY

In a situation, a radio communication apparatus (e.g., base station) selects a beam to be used for communication with a terminal apparatus, based on a measurement result of reception quality reported from the terminal apparatus. For this purpose, the radio communication apparatus selects a beam for measuring the reception quality from among a plurality of beam candidates. Beam failure may occur in a case in which the reception quality falls below a predetermined level. In view of this, the radio communication apparatus needs to appropriately select the beam such that the reception quality is equal to or higher than the predetermined level.

In 5G, the radio communication apparatus may have a plurality of transmission and reception points (TRPs). In this configuration, it is assumed that a first TRP and a second TRP are adjacent and a coverage area of the first TRP and a coverage area of the second TRP overlap each other. In this case, when the first TRP and the second TRP communicate with a terminal apparatus existing in an area where the first and second coverage areas overlap, interference occurs between the first TRP and the second TRP. The radio communication apparatus is required to appropriately select a beam in consideration of interference.

Although not limited to the above-described situation, the radio communication apparatus is required to appropriately select a beam in various situations. The present disclosure provides one or more techniques for selecting a beam appropriately.

In one or more example embodiments, a control apparatus is provided. The control apparatus includes one or more memories configured to store instructions, and one or more processors configured to execute the instructions to acquire a measurement result including information on reception qualities of a plurality of beams, update a database including information representing a relationship between the plurality of beams for each of a plurality of propagation environments, based on the measurement result, and perform selection processing for selecting a beam using the database.

In one or more example embodiments, a control method is provided. The control method includes acquiring a measurement result including information on reception qualities of a plurality of beams, updating a database including information representing a relationship between the plurality of beams for each of a plurality of propagation environments, based on the measurement result, and performing selection processing for selecting a beam using the database.

In one or more example embodiments, a non-transitory computer readable recording medium storing a program therein is provided. The program causes a computer including a processor and a memory to execute: acquiring a measurement result including information on reception qualities of a plurality of beams, updating a database including information representing a relationship between the plurality of beams for each of a plurality of propagation environments, based on the measurement result, and performing selection processing for selecting a beam using the database.

According to the configuration described above, the beam can be selected appropriately. Issues, configurations, and effects other than those described above become apparent in the following description of the example embodiments.

### BRIEF DESCRIPTION OF THE DRAWINGS

FIG. 1 is a diagram illustrating an example of a configuration of a radio communication system according to a first example embodiment.

FIG. 2 is a diagram illustrating an example of a configuration of a radio terminal.

FIG. 3 is a diagram illustrating an example of a configuration of a control apparatus.

FIG. 4 is a diagram illustrating an example of a configuration of a radio apparatus.

FIG. 5 is a diagram illustrating an example of a configuration of a baseband signal processing section.

FIG. 6 is a diagram illustrating an example of a configuration of a beam managing section and an example of a configuration of a storing section.

FIG. 7 is a diagram conceptually illustrating an example of a data structure of each of a plurality of tables included in a first database.

FIG. 8 is a flowchart for illustrating an example of a flow of processing for updating the first database.

FIG. 9 is a flowchart for illustrating an example of a flow of first selection processing.

FIG. 10 is a flowchart for illustrating an example of a flow of second selection processing.

FIG. 11 is a diagram conceptually illustrating an example of a data structure of each of a plurality of tables included in a second database.

FIG. 12 is a diagram conceptually illustrating an example of a data structure of each of a plurality of tables included in a third database.

FIG. 13 is a diagram conceptually illustrating an example of a data structure of each of a plurality of tables included in a fourth database.

FIG. 14 is a diagram illustrating an example of a configuration of a control apparatus according to a second example embodiment.

FIG. 15 is a diagram illustrating an example of a flow of processing of the control apparatus according to the second example embodiment.

FIG. 16 is a diagram illustrating an example of a combination of software and hardware for realizing the function of the control apparatus according to the second example embodiment.

### DESCRIPTION OF THE EXAMPLE EMBODIMENTS

In the following, one or more example embodiments will be described with reference to the accompanying drawings. Note that, in the Specification and drawings, elements to which similar descriptions are applicable are denoted by the same reference signs, and overlapping descriptions are hence omitted.

Descriptions will be given in the following order.

1. Overview of Example Embodiments

2. First Example Embodiment
2-1. Configuration of Radio Communication System
2-2. Configuration of Radio Terminal
2-3. Configuration of Radio Communication Apparatus
2-4. Configuration of Control Apparatus
2-5. Configuration of Radio Apparatus
2-6. Configuration of Baseband Signal Processing Section
2-7. Configuration of Beam Managing Section
2-8. Configuration of First Database
2-9. Operation Example of Beam Selecting Section
2-10. Flow of Processing
2-11. Effects
2-12. Example Alterations

3. Second Example Embodiment
3-1. Configuration of Control Apparatus
3-2. Flow of Processing

4. Other Example Embodiments

### 1. Overview of Example Embodiments

An overview of one or more example embodiments to be described later will be described.

### (1) Technical Issues

As described above, a radio communication apparatus (e.g., base station) is required to appropriately select a beam in various situations. Examples of such situations include a situation in which the radio communication apparatus selects a beam for measuring a reception quality, a situation in which the radio communication apparatus selects a beam to be used for communication with a terminal apparatus, and so on.

(2) Technical Features

In order to solve the above issue, a control apparatus according to one or more example embodiments is provided. The control apparatus includes an acquiring section, an updating section, and a selecting section.

The acquiring section acquires a measurement result including information on reception qualities of a plurality of beams. The updating section updates a database based on the measurement result. The database includes information representing a relationship between the plurality of beams for each of a plurality of propagation environments. The selecting section performs selection processing for selecting a beam using the database.

The selecting section may select the relationship corresponding to a present propagation environment in the information representing the relationship, and perform the selection processing using the selected relationship.

The information representing the relationship may include first information representing a first relationship of a difference in the reception quality between the plurality of beams. Further, the information representing the relationship may include second information representing a second relationship of a number of reports about the reception quality between the plurality of beams.

The selection processing may include one or both of first selection processing for selecting a beam to be used for measuring the reception quality, and second selection processing for selecting a beam to be used for communication with a radio terminal.

According to the configuration described above, the control apparatus can appropriately select the beam. Technical features of one or more example embodiments described below are not limited to those described above. In addition, one or more example embodiments described below may provide other effects instead of or in addition to the effects described above.

### 2. First Example Embodiment

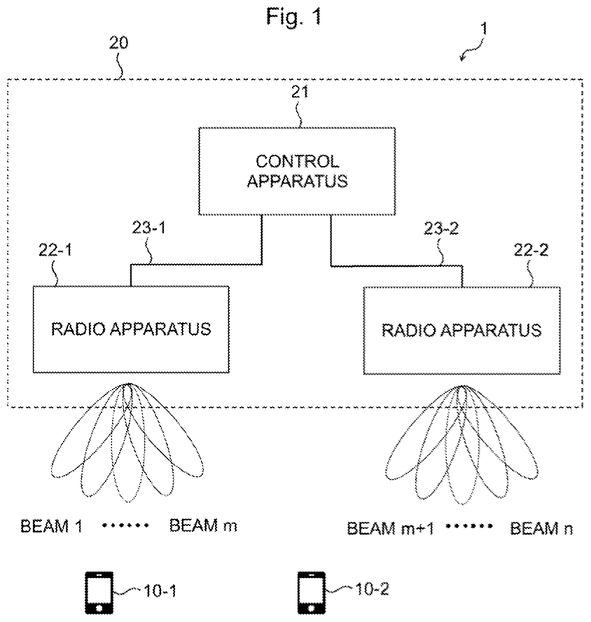

Next, with reference to FIG. 1 to FIG. 13 a first example embodiment and example alterations thereof will be described.

### 2-1. Configuration of Radio Communication System

FIG. 1 is a diagram illustrating an example of a configuration of a radio communication system 1. For example, the radio communication system 1 is a system in conformity to the technical specification of Third Generation Partnership Project (3GPP). Specifically, the radio communication system 1 may be a system in conformity to the technical specification of 5G. As a matter of course, the radio communication system 1 is not limited to this example.

The radio communication system 1 includes a plurality of radio terminals 10-1 and 10-2, and a radio communication apparatus 20. In the example of FIG. 1, the radio communication system 1 includes the two radio terminals 10-1 and 10-2, but the radio communication system 1 may include one radio terminal, or three or more radio terminals. Hereinafter, when it is not necessary to distinguish between the radio terminals 10-1 and 10-2, it may be simply referred to as “radio terminal 10”.

The radio terminal 10 may be referred to as a user equipment (UE), a mobile station, or the like. The radio terminal 10 is a mobile terminal, such as a smartphone, a mobile phone, or a tablet. The radio terminal 10 may be a relay apparatus having a relay function.

The radio communication apparatus 20 performs radio communication with the plurality of radio terminals 10-1 and 10-2. The radio communication apparatus 20 may be, for example, a node in a radio access network (RAN).

Hereinafter, a link on which a signal is transmitted from the radio communication apparatus 20 to the radio terminal 10 is referred to as “downlink”. A signal transmitted on the downlink is referred to as “downlink signal. Further, a link on which a signal is transmitted from the radio terminal 10 to the radio communication apparatus 20 is referred to as “uplink”. A signal transmitted on the uplink is referred to as “uplink signal”.

### 2-2. Configuration of Radio Terminal

The plurality of radio terminals 10-1 and 10-2 have the same configuration. Hereinafter, the configuration of the radio terminal 10-1 will be described, and the description of the radio terminal 10-2 is omitted.

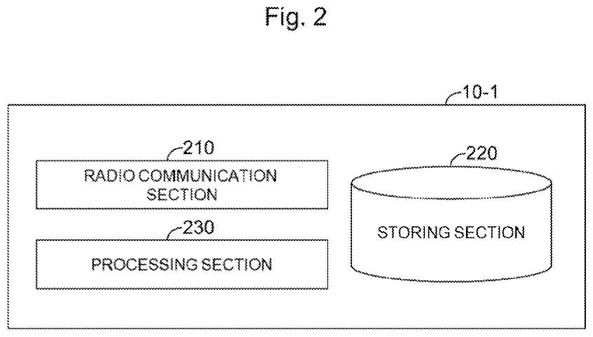

FIG. 2 is a block diagram illustrating an example of a configuration of the radio terminal 10-1. The radio terminal 10-1 includes a radio communication section 210, a storing section 220, and a processing section 230.

The radio communication section 210 is an element that performs radio communication with the radio communication apparatus 20. For example, the radio communication section 210 includes an antenna, a radio frequency (RF) circuit, and the like.

The storing section 220 includes a volatile memory and a non-volatile memory. The volatile memory may include, for example, a random access memory (RAM). The non-volatile memory may include, for example, one or more of a read only memory (ROM), a hard disk drive (HDD), and a solid state drive (SSD). The non-volatile memory stores a program code (instructions) for implementing various functions of the radio terminal 10-1.

The processing section 230 includes one or more processors. The one or more processors may include, for example, one or more of a central processing unit (CPU), a micro processing unit (MPU), and a micro controller. The processing section 230 implements various functions of the radio terminal 10-1 by executing the program code (instructions) stored in the storing section 220.

### 2-3. Configuration of Radio Communication Apparatus

As illustrated in FIG. 1, the radio communication apparatus 20 includes a control apparatus 21, and a plurality of radio apparatuses 22-1 and 22-2. In the example of FIG. 1, the radio communication apparatus 20 includes the two radio apparatuses 22-1 and 22-2, but the radio communication apparatus 20 may include one radio apparatus, or three or more radio apparatuses. Hereinafter, when it is not necessary to distinguish between the radio apparatuses 22-1 and 22-2, it may be simply referred to as “radio apparatus 22”.

For example, the control apparatus 21 may be a Central Unit or Centralized Unit (CU), a Distributed Unit (DU), or a RAN Intelligent Controller (RIC). The control apparatus 21 may be configured to have a partial function of a Radio Unit or Remote Unit (RU), for example.

At least one of the radio apparatuses 22-1 and 22-2 may be located physically apart from the control apparatus 21. For example, at least one of the radio apparatuses 22-1 and 22-2 may be a Radio Unit or Remote Unit (RU), Transmission and Reception Point (TRP), or Access Point (AP). Therefore, the radio communication apparatus 20 may have a configuration of Distributed Antenna Systems (DAS). The radio apparatuses 22-1 and 22-2 may be configured to have a partial function of RU.

The control apparatus 21 is connected to the radio apparatus 22-1 via a transmission path 23-1. The control apparatus 21 communicates with the radio apparatus 22-1 via the transmission path 23-1. The control apparatus 21 is connected to the radio apparatus 22-2 via a transmission path 23-2. The control apparatus 21 communicates with the radio apparatus 22-2 via the transmission path 23-2.

The transmission path 23-1 and the transmission path 23-2 are media used for information transmission. For example, each of the transmission paths 23-1 and 23-2 may be an optical fiber, a metal cable, or a radio propagation channel.

For example, Radio over Fiber (RoF) technology may be applied between the control apparatus 21 and the respective radio apparatuses 22-1 and 22-2. In other examples, Common Public Radio Interface (CPRI) technology, evolved Common Public Radio Interface (eCPRI) technology, and the like may be applied between the control apparatus 21 and the respective radio apparatuses 22-1 and 22-2.

The control apparatus 21 is connected to the plurality of radio apparatuses 22-1 and 22-2 as described above, and is configured to communicate with the plurality of radio terminals 10-1 and 10-2 via the plurality of radio apparatuses 22-1 and 22-2.

### 2-4. Configuration of Control Apparatus

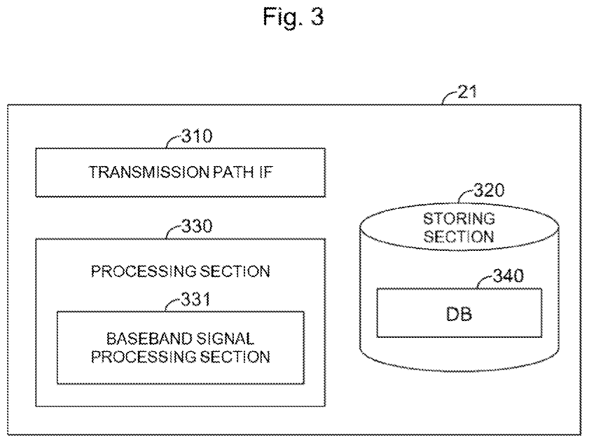

FIG. 3 is a block diagram illustrating an example of a configuration of the control apparatus 21. The control apparatus 21 includes a transmission path interface (IF) 310, a storing section 320, and a processing section 330.

The transmission path IF 310 includes an interface for communicating with the radio apparatus 22-1 via the transmission path 23-1, and an interface for communicating with the radio apparatus 22-2 via the transmission path 23-2.

The storing section 320 includes a volatile memory and a non-volatile memory. The volatile memory may include, for example, a RAM. The non-volatile memory may include, for example, one or more of a ROM, an HDD, and an SSD. The non-volatile memory stores a program code (instructions) for implementing various functions of the control apparatus 21.

Further, the non-volatile memory stores information (data) used for operation of the control apparatus 21. Specifically, the non-volatile memory stores a database (DB) 340.

The processing section 330 includes one or more processors. The one or more processors may include, for example, one or more of a CPU, an MPU, and a micro controller. The processing section 330 implements various functions of the control apparatus 21 by executing the program code (instructions) stored in the storing section 320.

The processing section 330 includes a baseband signal processing section 331 as a functional block (functional module). The baseband signal processing section 331 performs transmission processing and reception processing for a baseband signal. The processing section 330 may further include components other than the above functional block. That is, the processing section 330 may perform operations other than those performed by the functional block described above.

The radio apparatus 22 may include some of the functions of the baseband signal processing section 331. In one or more other examples, other devices (not shown) that are physically remote from the control apparatus 21 may include some of the functions of the baseband signal processing section 331. The detailed configuration of the baseband signal processing section 331 will be described later.

### 2-5. Configuration of Radio Apparatus

The plurality of radio apparatuses 22-1 and 22-2 have the same configuration. Hereinafter, the configuration of the radio apparatus 22-1 will be described, and the description of the radio apparatus 22-2 is omitted.

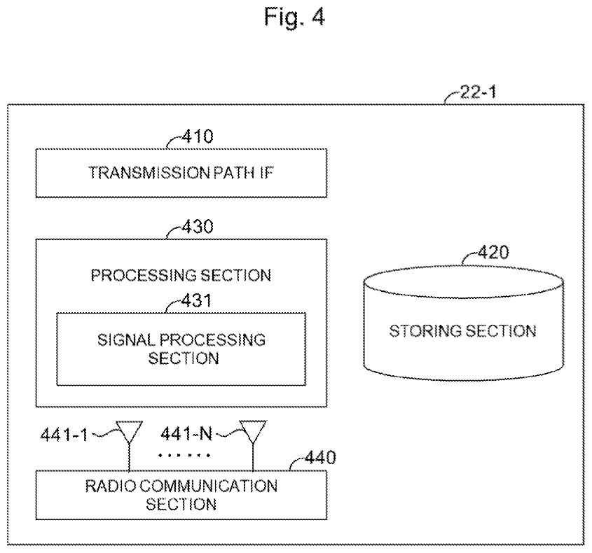

FIG. 4 is a block diagram illustrating an example of a configuration of the radio apparatus 22-1. The radio apparatus 22-1 includes a transmission path interface (IF) 410, a storing section 420, a processing section 430, a radio communication section 440.

The transmission path IF 410 is an interface for communicating with the control apparatus 21 via the transmission path 23-1.

The storing section 420 includes a volatile memory and a non-volatile memory. The volatile memory may include, for example, a RAM. The non-volatile memory may include, for example, one or more of a ROM, an HDD, and an SSD. The non-volatile memory stores a program code (instructions) for implementing various functions of the radio apparatus 22-1.

The processing section 430 includes one or more processors. The one or more processors may include, for example, one or more of a CPU, an MPU, and a micro controller. The processing section 430 implements various functions of the radio apparatus 22-1 by executing the program code (instructions) stored in the storing section 420.

The radio communication section 440 is an element that performs radio communication with the radio terminal 10. The radio communication section 440 transmits a radio frequency signal to the radio terminal 10, and receives a radio frequency signal from the radio terminal 10. For example, the radio communication section 440 may be implemented by a plurality of antennas and radio frequency (RF) circuits. Specifically, the radio communication section 440 includes a plurality of antennas (antenna elements) 441-1 to 441-N. N is an integer equal to or greater than 2.

In this example, the radio communication section 440 includes the plurality of antennas 441-1 to 441-N, but the configuration of the radio communication section 440 is not limited to this example. The radio communication section 440 may include one antenna capable of controlling the direction of the beam. For example, the radio communication section 440 may include a directional antenna such as a lens antenna or a metamaterial.

The processing section 430 includes a signal processing section 431 as a functional block (functional module). The signal processing section 431 performs processing for converting a baseband signal into a radio frequency signal, and processing for converting a radio frequency signal into a baseband signal. In another example, the control apparatus 21 may perform the above-described processes.

The signal processing section 431 controls the shape and direction (angle) of the beam formed by at least one of the plurality of antennas 441-1 to 441-N, that is, the signal processing section 431 performs beamforming. Specifically, the signal processing section 431 adjusts the amplitude and phase of the radio frequency signal. For this processing, the control apparatus 21 determines a set value of the amplitude and a set value of the phase, and notifies the signal processing section 431 of the above set values. The amplitude and phase may be adjusted for the baseband signal.

In this example, as illustrated in FIG. 1, the radio apparatus 22-1 is capable of forming a plurality of beams 1 to m. An Identifier is preassigned to each beam shape and direction. Hereinafter, the identifier is referred to as “beam number”. For example, beam numbers 1 to m are assigned to the beams 1 to m, respectively. In addition, the radio apparatus 22-2 is capable of forming a plurality of beams m+1 to n. Beam numbers m+1 to n are assigned to the beams m+1 to n, respectively.

### 2-6. Configuration of Baseband Signal Processing Section

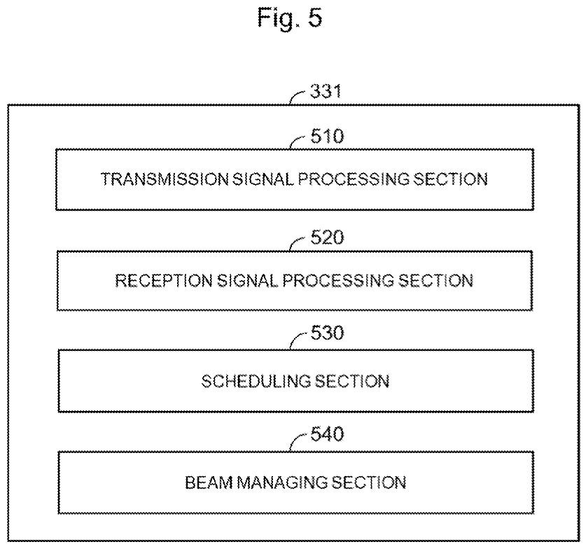

FIG. 5 is a block diagram illustrating an example of a configuration of the baseband signal processing section 331 in the control apparatus 21. The baseband signal processing section 331 includes a transmission signal processing section 510, a reception signal processing section 520, a scheduling section 530, and a beam managing section 540.

The transmission signal processing section 510 generates a signal to be transmitted to the radio terminal 10. The transmission signal processing section 510 transmits the generated signal to the radio apparatus 22 via the transmission path IF 310.

The reception signal processing section 520 receives a signal received by the radio apparatus 22 via the transmission path IF 310.

The radio apparatus 22 receives a measurement result about reception qualities of the beams from the radio terminal 10, and transmits the measurement result about the reception qualities of the beams to the reception signal processing section 520. The reception signal processing section 520 receives the measurement result about the reception qualities of the beams from the radio apparatus 22. The reception signal processing section 520 transmits the measurement result about the reception qualities to the beam managing section 540.

In this example, the above-described reception quality is information measured by the radio terminal 10 when the radio apparatus 22 transmits a downlink signal by using the transmitting beam. For example, the reception quality may be information representing a received power (e.g., Reference Signal Received Power (RSRP)). The received power is measured using, for example, a synchronization signal or a reference signal. The synchronization signal may be, for example, Secondary Synchronization Signal (SSS) in New Radio (NR). The reference signal may be, for example, Channel State Information-Reference Signal (CSI-RS) or NR Physical Broadcast Channel-Demodulation Reference Signal (PBCH-DMRS).

In another example, the reception quality may be information representing Reference Signal Received Quality (RSRQ), Signal to Noise Ratio (SNR), Signal to Interference Ratio (SIR), or Signal to Interference plus Noise Ratio (SINR).

Hereinafter, the measurement result about the reception qualities of the beams is referred to simply as “measurement result” for the sake of simplicity.

The scheduling section 530 allocates a radio resource used for communication with the radio terminal 10. For example, the radio resource may include antennas, beams, frequencies, times, etc. The scheduling section 530 transmits a result of the radio resource allocation to the transmission signal processing section 510 and the reception signal processing section 520.

Further, the scheduling section 530 transmits, to the radio apparatus 22 (specifically, the signal processing section 431) via the transmission path IF 310, information on a transmitting beam used when transmitting a radio frequency signal to the radio terminal 10, and information on a receiving beam used when receiving a radio frequency signal from the radio terminal 10.

In another example, the baseband signal processing section 331 may control the beam. In this configuration, the scheduling section 530 transmits the information on the transmitting beam to the transmission signal processing section 510. In accordance with the information, the transmission signal processing section 510 may perform controlling processing of the transmitting beam. Further, the scheduling section 530 transmits the information on the receiving beam to the reception signal processing section 520. In accordance with the information, the reception signal processing section 520 may perform controlling processing of the receiving beam.

The beam managing section 540 receives the measurement result from the reception signal processing section 520. The beam managing section 540 generates the DB 340 based on the measurement result. The DB 340 includes information representing a relationship between the plurality of beams 1 to n for each of a plurality of propagation environments. The beam managing section 540 updates the DB 340 based on the measurement result. The beam managing section 540 selects at least one beam from among the plurality of beams 1 to n by using the DB 340. The beam managing section 540 transmits information on the selected beam to the transmission signal processing section 510 or the scheduling section 530. Details of the beam managing section 540 will be described below.

### 2-7. Configuration of Beam Managing Section

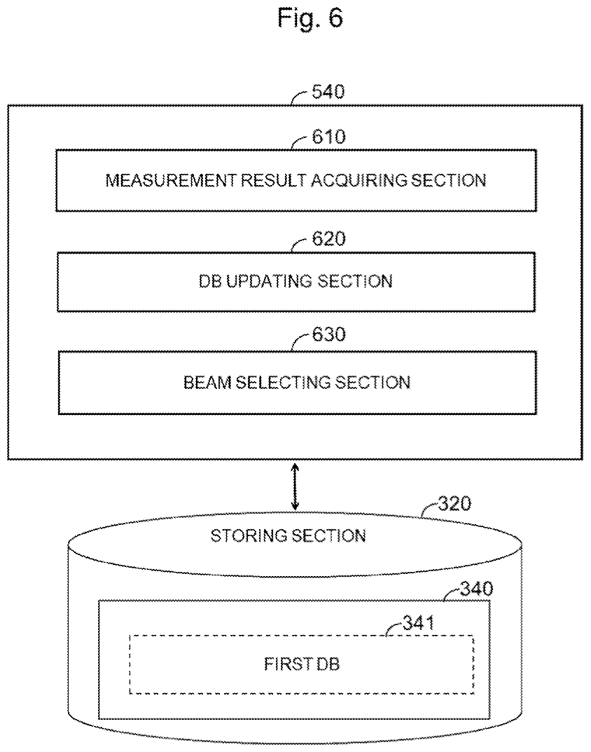

FIG. 6 is a block diagram illustrating an example of a configuration of the beam managing section 540 and an example of a configuration of the storing section 320. The beam managing section 540 includes a measurement result acquiring section 610, a database (DB) updating section 620, and a beam selecting section 630. The DB 340 includes a first database (DB) 341.

The measurement result acquiring section 610 receives (acquires) the measurement result from the reception signal processing section 520. An example in which the radio terminal 10-1 measures the reception qualities of the beams will be described below. For example, the radio apparatus 22-1 transmits a reference signal to the radio terminal 10-1. The radio terminal 10-1 measures the reception quality of the reference signal for each of a plurality of beams selected (instructed) by the beam managing section 540 (specifically, the beam selecting section 630). The radio terminal 10-1 transmits the measurement result to the radio apparatus 22-1. The measurement result includes information on the reception qualities of the plurality of beams.

In this example, the radio terminal 10-1 selects a predetermined number k1 of beams from among the measured beams in descending order of the reception quality. Then, the radio terminal 10-1 transmits (reports), as the measurement result, information on the reception qualities of the selected predetermined number k1 of beams to the radio apparatus 22-1. For example, k1 is an integer equal to or greater than 2. The measurement result acquiring section 610 transmits the measurement result to the DB updating section 620.

The DB updating section 620 receives the measurement result from the measurement result acquiring section 610. The DB updating section 620 generates and updates the first DB 341 using the measurement result. The DB updating section 620 may update the first DB 341 each time it receives the measurement result.

In another example, the DB updating section 620 may store (accumulate) measurement results until a predetermined period elapses, and update the first DB 341 each time the predetermined period elapses. In one or more other examples, if there is the radio terminal 10 having a small temporal variation in the reception quality, the DB updating section 620 may reduce a frequency of update for reflecting the measurement result received from the radio terminal 10 on the first DB 341. According to this configuration, since the frequency of update for the first DB 341 is reduced, the load on the update processing is reduced.

The beam selecting section 630 performs selection processing for selecting at least one beam from among the plurality of beams 1 to n using the first DB 341.

The selection processing includes first selection processing for selecting a plurality of beams to be used for measuring the reception quality. Hereinafter, the plurality of beams selected by the first selection processing are referred to as “a plurality of beams Bma”. The beam selecting section 630 transmits information on the plurality of beams Bma to the transmission signal processing section 510. Then, the transmission signal processing section 510 transmits, by using the plurality of beams Bma, a reference signal to the radio terminal 10 to be subjected to measurement processing. The radio terminal 10 measures the reception qualities of the plurality of beams Bma.

The selection processing includes second selection processing for selecting a beam to be used for communication with the radio terminal 10. Hereinafter, the radio terminal 10 to be communicated with is referred to as “radio terminal 10a”. Further, the beam selected by the second selection processing is referred to as “beam Bmb”. The beam selecting section 630 transmits information on the beam Bmb to the scheduling section 530. The scheduling section 530 allocates the beam Bmb for the radio terminal 10a. The radio communication apparatus 20 communicates with the radio terminal 10a by using the beam Bmb.

### 2-8. Configuration of First Database

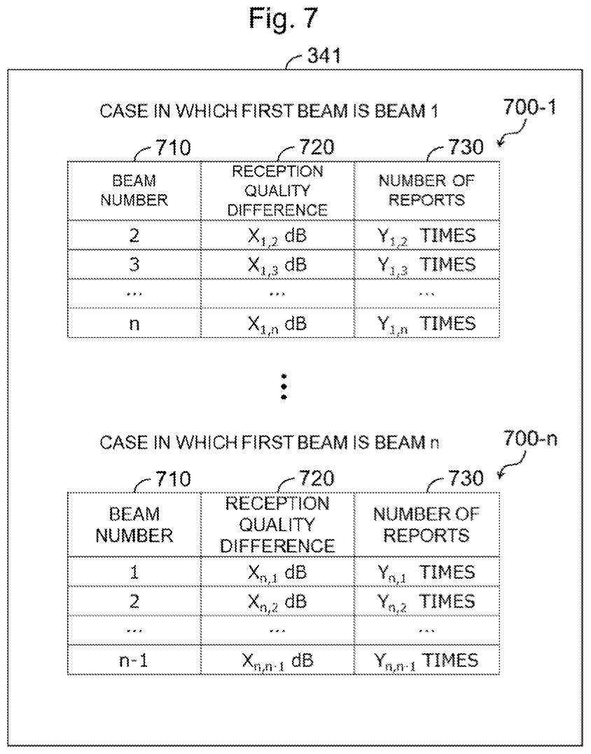

FIG. 7 is a diagram conceptually illustrating an example of a data structure of each of a plurality of tables 700-1 to 700-n included in the first DB 341. The data format of the first DB 341 is not limited to a table format, and may be another format.

An example in which the radio terminal 10-1 reports the measurement result to the radio communication apparatus 20 will be described in the same manner as described above. The measurement result reported from the radio terminal 10-1 includes information on a beam having the highest reception quality (hereinafter referred to as “first beam”) among the predetermined number k1 of beams. For example, the measurement result includes information on differences between the reception quality of the first beam and the respective reception qualities of the other beams. The measurement result may further include information representing respective values of the reception qualities of the predetermined number k1 of beams.

For example, a propagation environment in a case in which the first beam is the beam 1 may be different from a propagation environment in a case in which the first beam is the beam 2. The measurement results are organized for each propagation environment in order to select an appropriate beam. In the first DB 341, a plurality of propagation environments are distinguished based on the first beam. The first DB 341 includes information (first information) representing a relationship of the difference in the reception quality between the beams 1 to n for each of the plurality of propagation environments in which the first beams are different from each other. Hereinafter, the above-described relationship of the difference in the reception quality may be referred to as “first relationship”. In this example, the first relationship is a difference in the reception quality with respect to the reception quality of the first beam.

Further, the first DB 341 includes information (second information) representing a relationship of the number of reports about the reception quality between the beams 1 to n for each of the plurality of propagation environments in which the first beams are different from each other. Hereinafter, the above-described relationship of the number of reports about the reception quality may be referred to as “second relationship”. In this example, the second relationship represents a magnitude relationship in the number of reports between the beams 1 to n.

Specifically, the first DB 341 includes a plurality of tables 700-1 to 700-n. The table 700-1 includes “the first relationship and the second relationship” in a case in which the first beam is the beam 1. On the other hand, the table 700-n includes “the first relationship and the second relationship” in a case in which the first beam is the beam n. In the following, when it is not necessary to distinguish the plurality of tables 700-1 to 700-n, it may be simply referred to as “table 700”.

Since the plurality of tables 700-1 to 700-n have the same data structure, details of the table 700-1 will be described below.

The table 700-1 includes, as configuration items, a beam number 710, a reception quality difference 720, and a number of reports (number of times reported) 730. The above configuration items are stored in the first DB 341 in association with each other.

The beam number 710 is information for identifying a beam (beam of interest) as described above.

In this example, the reception quality difference 720 corresponds to the above-described first relationship, and represents the difference between the reception quality of the beam of interest and the reception quality of the first beam (in this example, the beam 1). In this example, the reception quality difference 720 is expressed by decibels (dB). “dB” is a unit for representing the relative difference in the intensity (level) of the received signal. The unit of dB is also used for the reception quality difference in the other DBs 342 to 344 described later. Of course, the reception quality difference 720 is not limited to this example, and may be expressed by other units depending on the reception quality used. The reception quality difference 720 may be the latest value or a representative value obtained from two or more reception quality differences. For example, the representative value may be an average value or a median value. The reception quality difference 720 may be information (e.g., rank information) indicating that the difference in the reception quality is large or small.

The radio terminal 10 reports the reception qualities about the predetermined number k1 of beams in descending order of the reception quality. Therefore, regarding the table 700-1, there is a possibility that there is a beam for which the reception quality is not reported. In this case, the DB updating section 620 may set the reception quality difference 720 corresponding to such a beam to a value larger than the maximum value of the reception quality difference 720 among the beams for which the reception qualities are reported.

The number of reports 730 corresponds to the above-described second relationship, and represents the number of times the measurement results have been reported. Specifically, the number of reports 730 represents the number of times that, in the case in which the first beam is the beam 1, the beam of interest is included in the measurement result together with the first beam (beam 1). The number of reports 730 may be a cumulative value, or an average value of cumulative values over a certain period of time. The number of reports 730 is not limited to the numerical value indicating the number of reports, and may be information (e.g., rank information) indicating that the number of reports is large or small.

### 2-9. Operation Example of Beam Selecting Section

Next, the operation of the beam selecting section 630 will be described. As described above, the first DB 341 includes the plurality of tables 700-1 to 700-n corresponding to the plurality of propagation environments. The beam selecting section 630 selects one table 700 corresponding to the present propagation environment based on the present communication status with the radio terminal 10. The beam selecting section 630 performs the selection processing using the reception quality difference 720 (first relationship) or the number of reports 730 (second relationship) included in the selected table 700.

Next, detailed contents of the first selection processing and the second selection processing will be described.

### (1) First Selection Processing

Here, an example in which the beam selecting section 630 selects the plurality of beams Bma for which reception qualities are to be measured by the radio terminal 10-1 will be described.

In this example, the beam selecting section 630 performs the first selection processing at the following first to third time points.

First time point: a time point at which the radio terminal 10-1 is initially connected to a cell covered by the radio communication apparatus 20.

Second time point: a time point at which the beam used to communicate with the radio terminal 10-1 is changed. The second time point may be, for example, a time point at which the beam Bmb is determined.

Third time point: a time point at which the first DB 341 is updated.

The processing at the first time point will be described below as an example. At the first time point, the beam selecting section 630 acquires the beam number used when the radio terminal 10-1 is initially connected to the cell covered by the radio communication apparatus 20. For example, the beam selecting section 630 can acquire information on the beam number from the component (e.g., the reception signal processing section 520 or the beam managing section 540) of the baseband signal processing section 331.

For example, it is assumed that the radio terminal 10-1 is initially connected to the cell using the beam 1. In this case, the beam selecting section 630 acquires information on the beam number 1. The beam selecting section 630 selects, as the plurality of beams Bma, a plurality of beams each having the reception quality having a small difference with respect to the reception quality of the beam (i.e., beam 1) currently used. This is because of the following reasons. The beam having the reception quality with a small difference with respect to the reception quality of the beam 1 is likely to have a coverage area close to or adjacent to that of the beam 1. Therefore, a relatively high reception quality can be expected to be measured.

Specifically, the beam selecting section 630 regards the beam currently in use (i.e., beam 1) as the first beam, and selects one table 700 corresponding to the present propagation environment. In this example, the beam selecting section 630 refers to the table 700-1 corresponding to the case in which the first beam is the beam 1. In the table 700-1, the beam selecting section 630 selects, as the plurality of beams Bma, a predetermined number k2 of beams in ascending order of the reception quality difference 720. k2 is an integer equal to or greater than 2.

According to this configuration, the beam selecting section 630 can select, as the plurality of beams Bma, the beams each having the reception quality with a small difference compared to the reception quality of the beam 1. Therefore, when the radio terminal 10-1 measures the reception qualities of the plurality of beams Bma, there is a high possibility that one or more reception qualities among the plurality of beams Bma satisfy a predetermined level. Accordingly, beam failure can be avoided. That is, the communication between the radio terminal 10-1 and the radio communication apparatus 20 can be prevented from being disconnected.

According to another example, in the table 700-1, the beam selecting section 630 may select, as the plurality of beams Bma, the predetermined number k2 of beams in descending order of the number of reports 730. The beam for which the number of reports 730 is large indicates that this beam is included in the measurement result a large number of times together with the first beam (in this example, beam 1). The reception quality of such a beam may have a small difference with respect to the reception quality of the first beam. In other words, the beam for which the number of reports 730 is large is likely to have a coverage area close to or adjacent to that of the first beam. Therefore, a relatively high reception quality can be expected to be measured. In addition, as described above, beam failure can be avoided. That is, the communication between the radio terminal 10-1 and the radio apparatus 22 can be prevented from being disconnected.

### (2) Second Selection Processing

Here, an example in which the beam selecting section 630 selects the beam Bmb to be used for communication with the radio terminal 10-2 in the case in which the radio communication apparatus 20 communicates with the plurality of radio terminals 10-1 and 10-2 will be described.

The beam selecting section 630 acquires information on the beam number currently used (currently assigned) from the scheduling section 530. For example, it is assumed that the radio communication apparatus 20 currently communicates with the radio terminal 10-1 using the beam 1.In this case, the beam selecting section 630 acquires information on the beam number 1. The beam selecting section 630 selects, as the beam Bmb, a beam having the reception quality having a large difference with respect to the reception quality of the beam (i.e., beam 1) currently in use. This is because of the following reasons. The beam having the reception quality with a large difference with respect to the reception quality of the beam 1 is likely to have a coverage area away from the coverage area of the beam 1. Therefore, it can be expected that interference with the beam 1 is reduced.

Specifically, the beam selecting section 630 regards the beam currently in use (i.e., beam 1) as the first beam, and selects one table 700 corresponding to the present propagation environment. In this example, the beam selecting section 630 refers to the table 700-1 corresponding to the case in which the first beam is the beam 1. In the table 700-1, the beam selecting section 630 selects, as the beam Bmb, a beam for which the reception quality difference 720 is equal to or greater than a predetermined first threshold Th1.

According to this configuration, there is a high possibility that the beam Bmb has a coverage area away from the coverage area of the first beam (in this example, beam 1). In the case in which the radio communication apparatus 20 communicates with the radio terminal 10-2 using the beam Bmb, interference with the beam 1 currently used can be reduced.

In the case in which the radio communication apparatus 20 currently uses two or more beams, the beam selecting section 630 may regard the two or more beams as the first beams, and refer to two or more tables 700. For each of the two or more tables 700, the beam selecting section 630 may select, as the beam Bmb, a beam for which the reception quality difference 720 is equal to or greater than the predetermined first threshold Th1.

Further, the beam selecting section 630 may select the beam Bmb as follows. The beam selecting section 630 selects, as a beam candidate Bmb′, a beam for which the reception quality difference 720 is equal to or greater than the predetermined first threshold Th1 in the table 700-1. Here, it is assumed that the beam candidate Bmb′ is the beam n. In this case, the beam selecting section 630 refers to the table 700-n corresponding to the case in which the first beam is the beam candidate Bmb′ (i.e., beam n). The beam selecting section 630 determines the beam candidate Bmb′ (i.e., beam n) as the beam Bmb in the case in which the reception quality difference 720 with respect to the reception quality of the beam 1 is equal to or greater than the predetermined first threshold Th1 in the table 700-n. According to this configuration, the effect of reducing interference with the beam 1 currently used can be further enhanced.

In further other example, the beam selecting section 630 may select, as the beam Bmb, a beam for which the number of reports 730 is less than a predetermined second threshold Th2 in the table 700-1. The beam for which the number of reports 730 is small indicates that the number of times this beam is included in the measurement result together with the first beam (in this example, beam 1) is small. Such a beam is likely to have a coverage area away from the coverage area of the first beam. According to this configuration, when the radio communication apparatus 20 communicates with the radio terminal 10-2 using the beam Bmb, interference with the beam 1 currently used can be reduced.

### 2-10. Flow of Processing

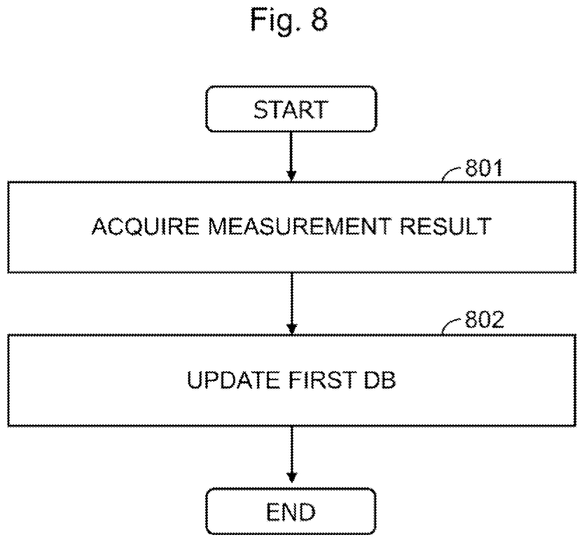

Next, the flow of processing in the control apparatus 21 will be described with reference to FIGS. 8 to 10.

FIG. 8 is a flowchart for illustrating an example of a flow of processing for updating the first DB 341. The measurement result acquiring section 610 acquires the measurement result (801). The measurement result acquiring section 610 transmits the measurement result to the DB updating section 620. The DB updating section 620 updates the first DB 341 using the measurement result (802).

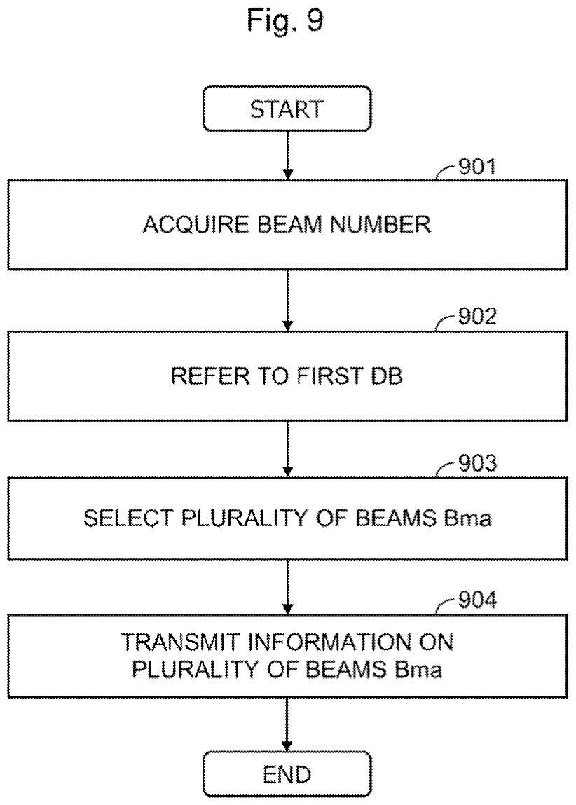

FIG. 9 is a flowchart for illustrating an example of a flow of the first selection processing. The beam selecting section 630 executes the flowchart of FIG. 9 at the first time point. The beam selecting section 630 acquires the beam number used when the radio terminal 10 is initially connected to the cell covered by the radio communication apparatus 20 (901). Next, the beam selecting section 630 refers to the first DB 341 (902). Specifically, the beam selecting section 630 regards the beam corresponding to the beam number acquired in step 901 as the first beam, and refers to the first DB 341. The beam selecting section 630 refers to the table 700 corresponding to the case in which the first beam is the beam corresponding to the beam number acquired in step 901. Next, in the table 700 referred to in step 902, the beam selecting section 630 selects the plurality of beams Bma as described above (903). Then, the beam selecting section 630 transmits information on the plurality of beams Bma to the transmission signal processing section 510 (904).

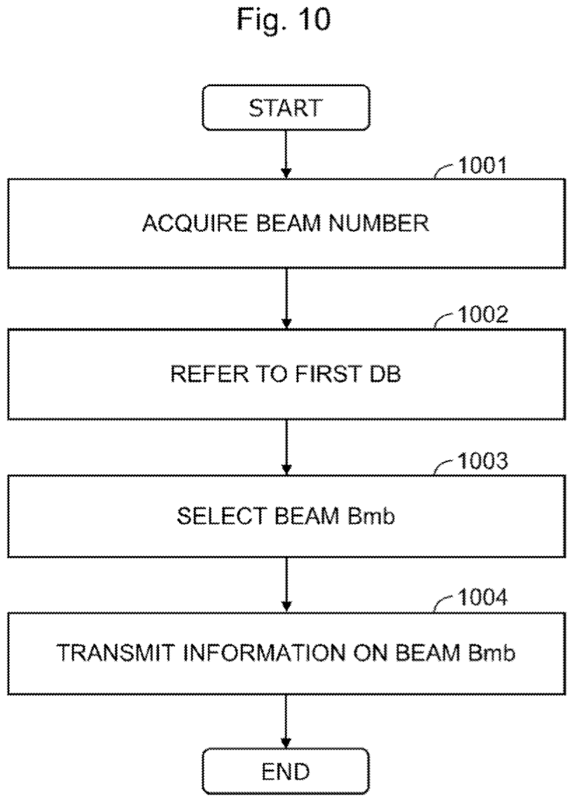

Further, the beam selecting section 630 executes the flowchart in FIG. 9 at the second time point. For example, the beam selecting section 630 may execute the flowchart of FIG. 9 after executing the flowchart of FIG. 10 described later. In this case, the beam selecting section 630 acquires information on the beam Bmb in step 901. Then, in step 902, the beam selecting section 630 regards the beam (i.e., the beam Bmb) to be used next as the first beam, and selects one table 700 corresponding to the present propagation environment. Specifically, the beam selecting section 630 refers to the table 700 corresponding to the case in which the first beam is the beam Bmb. The subsequent processing is the same as described above.

Further, he beam selecting section 630 executes the flowchart in FIG. 9 at the third time point. In this case, the beam selecting section 630 acquires the beam number currently used from the scheduling section 530 in step 901. The subsequent processing is the same as described above.

FIG. 10 is a flowchart for illustrating an example of a flow of the second selection processing. The beam selecting section 630 acquires from the scheduling section 530 the beam number currently assigned (1001). Next, the beam selecting section 630 refers to the first DB 341 (1002). Specifically, the beam selecting section 630 regards the beam corresponding to the beam number acquired in step 1001 as the first beam, and refers to the first DB 341. The beam selecting section 630 refers to the table 700 corresponding to the case in which the first beam is the beam corresponding to the beam number acquired in step 1001. Next, the beam selecting section 630 selects the beam Bmb in the table 700 referred to in step 1002 (1003). Then, the beam selecting section 630 transmits information on the beam Bmb to the scheduling section 530 (1004).

### 2-11. Effects

The configuration described above provides the following effects. The control apparatus 21 updates the first DB 341 using the measurement result. The control apparatus 21 can perform the first selection processing and the second selection processing using the first DB 341 to select a beam suitable for the present propagation environment.

For example, NPL 1 discloses a method for selecting a beam to reduce interference between TRPs. In the method disclosed in NPL 1, the position of a radio terminal is estimated in an environment in which there is no obstacle between the TRP and the radio terminal. The beam is selected using the estimated position of the radio terminal. Therefore, in the method disclosed in NPL 1, there is a possibility that the beam cannot be appropriately selected in an environment in which there is an obstacle between the TRP and the radio terminal.

Meanwhile, as described above, the first DB 341 includes information on the first relationship (e.g., the reception quality difference 720) and the second relationship (e.g., the number of reports 730) for each of the plurality of propagation environments in which the first beams are different from each other. The control apparatus 21 selects one propagation environment (i.e., table 700) corresponding to the present propagation environment from among the plurality of propagation environments, and selects the plurality of beams Bma in the selected propagation environment (table 700) by using the first relationship (e.g., the reception quality difference 720) or the second relationship (e.g., the number of reports 730). That is, the control apparatus 21 selects the plurality of beams Bma in consideration of the propagation environment and the reception qualities of the beams. Therefore, even in an environment in which there are obstacles between the radio terminal 10 and the radio apparatuses 22-1 and 22-2, the plurality of beams Bma can be appropriately selected for measuring the reception qualities of the beams. As a result, the communication between the radio terminal 10 and the radio communication apparatus 20 can be prevented from being disconnected.

Similarly, the control apparatus 21 selects one propagation environment (i.e., table 700) corresponding to the present propagation environment from among the plurality of propagation environments, and selects the beam Bmb in the selected propagation environment (table 700) by using the first relationship (e.g., the reception quality difference 720) or the second relationship (e.g., the number of reports 730). The control apparatus 21 can select, as the beam Bmb, a beam capable of reducing interference with the beam currently in use.

### 2-12. Example Alterations

The technique related to the present disclosure is not limited to the example embodiment described above. Two or more example aspects optionally selected from the above example embodiment and the following example alterations may be suitably combined as long as they do not contradict each other.

### (1) First Example Alteration

The reception signal processing section 520 may measure a reception quality of a receiving beam based on a received uplink signal. In this configuration, the reception signal processing section 520 measures a reception quality of a reference signal received by the radio apparatus 22. The reception signal processing section 520 transmits a measurement result to the measurement result acquiring section 610. The beam selecting section 630 transmits information on the plurality of beams Bma to the reception signal processing section 520. The reception signal processing section 520 measures reception qualities of reference signals received by the plurality of beams Bma.

### (2) Second Example Alteration

In the second selection processing, the beam selecting section 630 may select one or more beams that should not be used for communication with the radio terminal 10 (that is, should not be assigned to the radio terminal 10), and transmit information on the selected one or more beams to the scheduling section 530. In this configuration, the beam selecting section 630 may select, as the beam Bmb, a beam for which the reception quality difference 720 is less than a predetermined third threshold Th3 in the table 700 corresponding to the currently allocated beam. In another example, the beam selecting section 630 may select, as the beam Bmb, a beam of which the number of reports 730 is equal to or greater than a predetermined fourth threshold Th4.

### (3) Third Example Alteration

The beam selecting section 630 may predict whether the first beam is to be switched, based on a temporal variation of the reception quality of the beam. In this configuration, the beam selecting section 630 may perform the first selection processing and the second selection processing based on the above prediction. For example, it is assumed that the beam selecting section 630 predicts that the first beam is to be switched from the beam 1 to the beam 2 based on the reception qualities of the beams included in the measurement result. In this case, the beam selecting section 630 may perform the first selection processing and the second selection processing with reference to the table 700-2 corresponding to the beam 2. According to this configuration, it is possible to avoid degradation in communication quality that may occur when the beam is switched.

### (4) Fourth Example Alteration

The configuration of the DB 340 is not limited to the above example (the first DB 341). In the table 700 of the first DB 341, either the reception quality difference 720 or the number of reports 730 may be omitted.

In addition, the table 700 may include information identifying the radio apparatus 22 as an additional configuration item. In this configuration, the beam selecting section 630 may perform the first selection processing as follows. For example, it is assumed that the radio terminal 10-1 is initially connected to the cell of the radio apparatus 22-1 using the beam 1. The beam selecting section 630 may select the plurality of beams Bma such that the plurality of beams Bma include two or more beams formed by the plurality of radio apparatuses 22-1 and 22-2. That is, the beam selecting section 630 may select the plurality of beams Bma such that at least one of the beams 1 to m and at least one of the beams m+1 to n are included in the plurality of beams Bma. According to this configuration, even in a case in which the disconnection between the radio terminal 10-1 and the radio apparatus 22-1 occurs, the radio terminal 10-1 can smoothly switch to the radio apparatus 22-2.

### (5) Fifth Example Alteration

The control apparatus 21 may measure the reception quality for the purpose of updating the DB 340 in order to improve the accuracy of the DB 340. In this configuration, the DB updating section 620 may select the radio terminal 10 having a small influence on communication as the radio terminal for measurement. Hereinafter, such a radio terminal for measurement is called “radio terminal 10b”.

For example, the DB updating section 620 may select the radio terminal 10 for which the amount of communication data is currently zero (or, the radio terminal 10 for which the amount of communication data is relatively small) as the radio terminal 10b. In another example, the DB updating section 620 may select the radio terminal 10 moving at a low speed or the radio terminal 10 in a stationary state as the radio terminal 10b. For these radio terminals, handover and beam switching are unlikely to occur, and it is considered that there is a low need to measure reception qualities. The DB updating section 620 may select the above-mentioned radio terminal 10 as the radio terminal 10b, and cause the radio terminal 10b to measure the reception quality for the purpose of updating the DB 340.

### (6) Sixth Example Alteration

The DB updating section 620 may select a beam for updating the DB 340 in order to improve the accuracy of the DB 340. Specifically, the DB updating section 620 may indicate to the radio terminal 10 a beam to be included in the measurement result. According to this configuration, the radio terminal 10 reports the reception quality of the indicated beam to the radio communication apparatus 20 regardless of the reception quality. To achieve this, when notifying the radio terminal 10 of the plurality of beams Bma, the DB updating section 620 may transmit instruction information for instructing the radio terminal 10 about the reception qualities of the beams to be included in the measurement result together information on the plurality of beams Bma. The instruction information may be a control message or flag. Further, the DB updating section 620 may transmit the instruction information such that the reception qualities of two or more beams formed by the plurality of radio apparatuses 22-1 and 22-2 are included in the measurement result. That is, the DB updating section 620 may transmit the instruction information such that at least one of the beams 1 to m and at least one of the beams m+1 to n are included in the measurement result. In another example, the DB updating section 620 may transmit the instruction information instructing to report reception qualities of all the plurality of beams Bma. Therefore, the DB updating section 620 can efficiently acquire the necessary measurement results.

### (7) Seventh Example Alteration

The DB 340 may store one or more of a second DB 342, a third DB 343, and a fourth DB 344, in place of or in addition to the first DB 341.

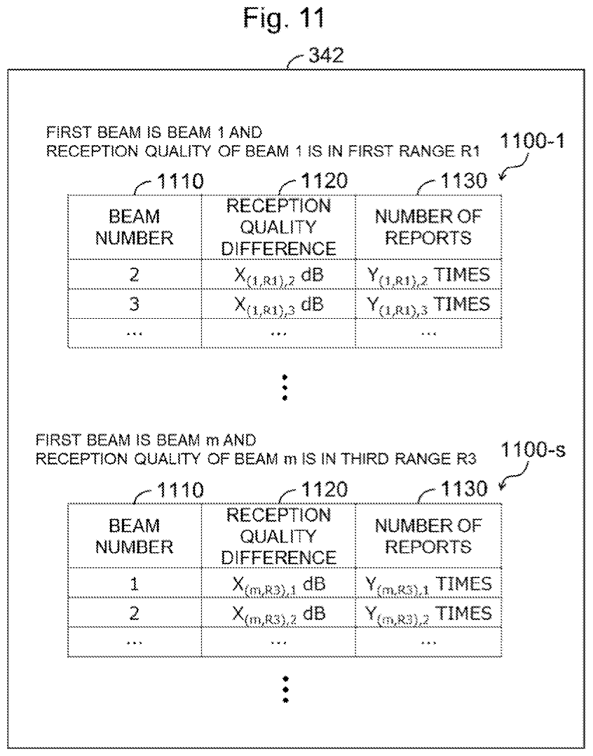

FIG. 11 is a diagram conceptually illustrating an example of a data structure of each of a plurality of tables 1100-1 to 1100-s included in the second DB 342.

In the second DB 342, the plurality of propagation environments are distinguished based on the first beam and the reception quality of the first beam. For example, a propagation environment in which the first beam is the beam 1 and the reception quality of the beam 1 is relatively low may be different from a propagation environment in which the first beam is the beam 1 and the reception quality of the beam 1 is relatively high. For example, in a situation in which the reception quality of the beam 1 is low, the radio terminal 10 may be present at the end of the coverage area of the beam 1. On the other hand, in a situation in which the reception quality of the beam 1 is high, there is a possibility that the radio terminal 10 is present near the center of the coverage area of the beam 1. The second DB 342 may be referred to as a database reflecting the difference in positional relationship between the radio terminal 10 and the coverage area (i.e., the difference between the propagation environments).

In this example, the reception quality of the first beam includes a first range R1, a second range R2, and a third range R3. The first range R1 is a range in which the value of the reception quality is less than a predetermined first value z1. The second range R2 is a range in which the value of the reception quality is equal to or greater than the first value z1, and less than a predetermined second value z2. The third range R3 is a range in which the value of the reception quality is equal to or greater than the second value z2.

In this example, the reception quality of the first beam is divided into the three ranges, but is not limited to this configuration. The reception quality of the first beam may be divided into two ranges, or four or more ranges.

Specifically, the second DB 342 includes the plurality of tables 1100-1 to 1100-s. Hereinafter, when it is not necessary to distinguish between the tables 1100-1 to 1100-s, it may be simply referred to as “table 1100”.

Since the plurality of tables 1100-1 to 1100-s have the same structure, the table 1100-1 will be described below. The table 1100-1 is a table corresponding to “the case in which the first beam is the beam 1 and the reception quality of the beam 1 is in the first range R1”.

The table 1100-1 includes, as configuration items, a beam number 1110, a reception quality difference 1120, and a number of reports 1130. The above configuration items are stored in the second DB 342 in association with each other. The beam number 1110, the reception quality difference 1120, and the number of reports 1130 are the same as the beam number 710, the reception quality difference 720, and the number of reports 730 described above, respectively. Therefore, a detailed description thereof is omitted.

In this configuration, the DB updating section 620 updates the plurality of tables 1100-1 to 1100-s according to the value of the reception quality of the first beam.

The beam selecting section 630 selects one propagation environment (i.e., the table 1100) corresponding to the present propagation environment from among the plurality of propagation environments, based on the first beam determined from the measurement result acquired at the present time and the reception quality of the first beam. The beam selecting section 630 performs the selection processing using the first relationship (the reception quality difference 1120) or the second relationship (the number of reports 1130) in the selected propagation environment (table 1100).

For example, the beam selecting section 630 performs the first selection processing as follows. The beam selecting section 630 acquires the measurement result from the measurement result acquiring section 610. The beam selecting section 630 determines the first beam and the reception quality of the first beam from the measurement result. It is assumed that the first beam is the beam 1 and the reception quality of the beam 1 is in the first range R1. In this case, the beam selecting section 630 refers to the table 1100-1 and selects the plurality of beams Bma as described above.

For example, the beam selecting section 630 performs the second selection processing as follows. An example in which the beam selecting section 630 selects the beam Bmb to be used for communication with the radio terminal 10-2 will be described. It is assumed that the radio communication apparatus 20 currently communicates with the radio terminal 10-1 using the beam 1. The beam selecting section 630 acquires the measurement result from the measurement result acquiring section 610. The beam selecting section 630 determines the first beam and the reception quality of the first beam from the measurement result. In the case in which the first beam is the beam 1 and the reception quality of the beam 1 is in the first range R1, the beam selecting section 630 refers to the table 1100-1, and selects the beam Bmb as described above.

According to this configuration, the second DB 342 includes information on the first relationship and the second relationship for each range of reception quality of the first beam. Therefore, the second DB 342 reflects (includes) more propagation environments than the first DB 341. The effect of appropriately selecting the beam can be further enhanced.

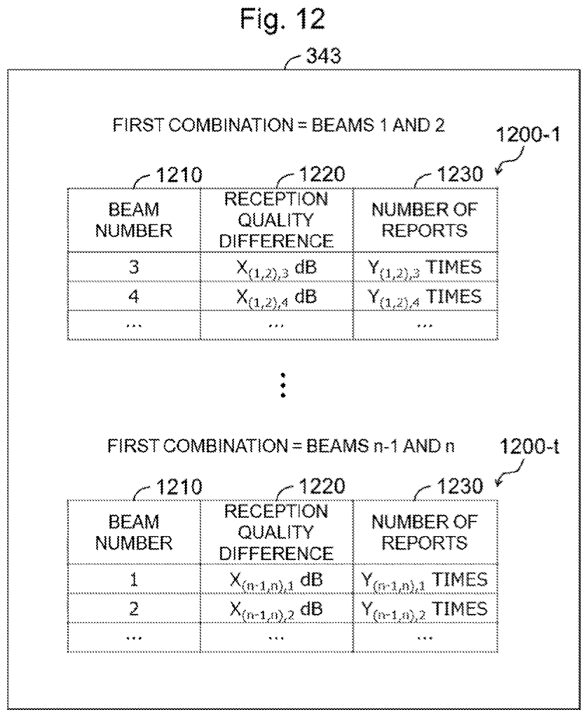

FIG. 12 is a diagram conceptually illustrating an example of a data structure of each of a plurality of tables 1200-1 to 1200-t included in the third DB 343.

In the third DB 343, the plurality of propagation environments are distinguished based on a first combination of beams. Here, the “first combination of beams” means a combination of a beam having the highest reception quality (referred to as “first beam” in the same manner as described above) and a beam having the second highest reception quality (hereinafter referred to as “second beam”) among the predetermined number k1 of beams included in the measurement result. Hereinafter, the “first combination of beams” will be referred to simply as “first combination”.

For example, a propagation environment in which the first beam is the beam 1 and the second beam is the beam 2 is different from a propagation environment in which the first beam is the beam 1 and the second beam is the beam 3. The third DB 343 is a database reflecting such a difference between the propagation environments.

Specifically, the third DB 343 includes the plurality of tables 1200-1 to 1200-t. Hereinafter, when it is not necessary to distinguish between the tables 1200-1 to 1200-t, it may be simply referred to as “table 1200”.

Since the plurality of tables 1200-1 to 1200-t have the same structure, the table 1200-1 will be described below. The table 1200-1 is a table corresponding to “the case in which the first combination is the combination of the beam 1 and the beam 2”.

The table 1200-1 includes, as configuration items, a beam number 1210, a reception quality difference 1220, and a number of reports 1230. The above configuration items are stored in the third DB 343 in association with each other.

The beam number 1210 and the number of reports 1230 are the same as the beam number 710 and the number of reports 730 described above, respectively. Therefore, a detailed description thereof is omitted.

The reception quality difference 1220 may be a difference with respect to the reception quality of the first beam. The reception quality difference 1220 may be a difference with respect to the reception quality of the second beam. The reception quality difference 1220 may be an average value of the difference with respect to the reception quality of the first beam and the difference with respect to the reception quality of the second beam.

In this configuration, the DB updating section 620 acquires the measurement result from the measurement result acquiring section 610. The beam selecting section 630 determines the first combination from the measurement result. Then, the DB updating section 620 updates the table 1200 corresponding to the determined first combination.

The beam selecting section 630 selects one propagation environment (i.e., the table 1200) corresponding to the present propagation environment from among the plurality of propagation environments, based on the first combination determined from the measurement result acquired at the present time. The beam selecting section 630 performs the selection processing using the first relationship (the reception quality difference 1220) or the second relationship (the number of reports 1230) in the selected propagation environment (the table 1200).

For example, the beam selecting section 630 performs the first selection processing as follows. The beam selecting section 630 acquires the measurement result from the measurement result acquiring section 610. The beam selecting section 630 determines the first combination from the measurement result. It is assumed that the first combination is the combination of the beam 1 and the beam 2. In this case, the beam selecting section 630 refers to the table 1200-1 and selects the plurality of beams Bma as described above.

For example, the beam selecting section 630 performs the second selection processing as follows. An example in which the beam selecting section 630 selects the beam Bmb to be used for communication with the radio terminal 10-2 will be described. It is assumed that the radio communication apparatus 20 currently communicates with the radio terminal 10-1 using the beam 1. The beam selecting section 630 acquires the measurement result from the measurement result acquiring section 610. The beam selecting section 630 determines the first combination from the measurement result. It is assumed that the first combination is the combination of the beam 1 and the beam 2. In this case, the beam selecting section 630 refers to the table 1200-1, and selects the beam Bmb as described above. Meanwhile, even in the case in which the beam 2 is currently used and the first combination is the combination of the beam 1 and the beam 2, the beam selecting section 630 refers to the table 1200-1.

According to this configuration, the third DB 343 includes information on the first relationship and the second relationship for each of first combinations. Therefore, the third DB 343 reflects (includes) more propagation environments than the first DB 341. The effect of appropriately selecting the beam can be further enhanced.

The third DB 343 may be referred to at the time of beam switching (e.g., at the time of handover). For example, when the beam used for communication with the radio terminal 10-1 is switched from the beam 1 to the beam 2, the beam selecting section 630 may refer to the table 1200-1 and select the plurality of beams Bma as described above.

In the third DB 343, the combination of two beams is used, but the configuration is not limited to this. The third DB 343 may be constructed to include information on the first relationship and the second relationship for each combination of three or more beams.

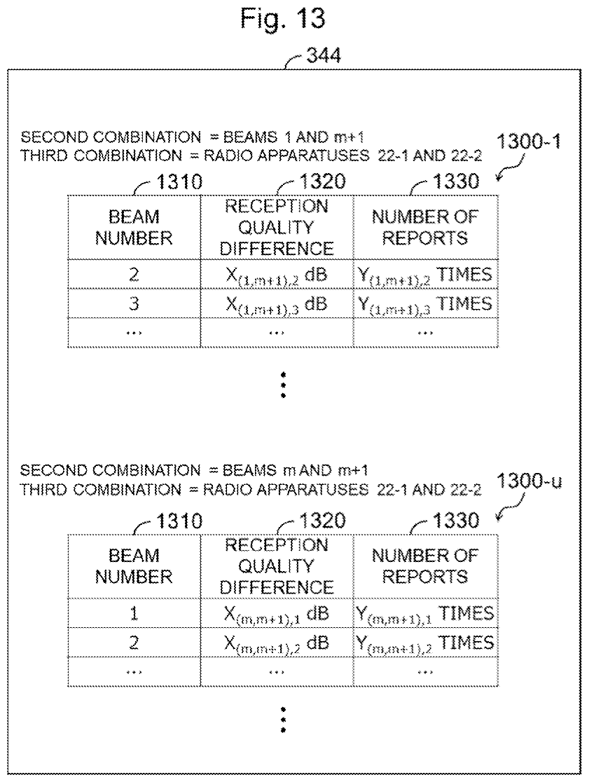

FIG. 13 is a diagram conceptually illustrating an example of a data structure of each of a plurality of tables 1300-1 to 1300-u included in the fourth DB 344. In this example, it is assumed that the control apparatus 21 is connected to three or more radio apparatuses 22.

In the fourth DB 344, the plurality of propagation environments are distinguished based on a second combination of beams and a third combination of radio apparatuses. The “third combination of radio apparatuses” herein means a “combination of a first radio apparatus and a second radio apparatus” included in three or more radio apparatuses 22. The first radio apparatus is a radio apparatus 22 forming a third beam having the highest reception quality in a first beam set. The second radio apparatus is a radio apparatus 22 forming a fourth beam having the highest reception quality in a second beam set. The first beam set is a set of all beams included in the measurement result. The second beam set is a set in which beams formed by the first radio apparatus are deleted from the first beam set. Further, “second combination of beams” herein is a combination of the third beam and the fourth beam. Hereinafter, the “second combination of beams” is referred to simply as “second combination”, and the “third combination of radio apparatuses” is referred to simply as “third combination”. The fourth DB 344 may be referred to as a database reflecting the difference in the propagation environment from the viewpoint of the reception quality of each of two radio apparatuses.

Specifically, the fourth DB 344 includes the plurality of tables 1300-1 to 1300-u. Hereinafter, when it is not necessary to distinguish between the tables 1300-1 to 1300-u, it may be simply referred to as “table 1300”.

Since the plurality of tables 1300-1 to 1300-u have the same structure, the table 1300-1 will be described below. The table 1300-1 is a table corresponding to “the case in which the second combination is the combination of the beam 1 and the beam m+1, and the third combination is the combination of the radio apparatus 22-1 and the radio apparatus 22-2”.

The table 1300-1 includes, as configuration items, a beam number 1310, a reception quality difference 1320, and a number of reports 1330. The above configuration items are stored in the fourth DB 344 in association with each other.

The beam number 1310 and the number of reports 1330 are the same as the beam number 710 and the number of reports 730 described above, respectively. Therefore, a detailed description thereof is omitted.

The reception quality difference 1320 may be a difference with respect to the reception quality of the third beam. The reception quality difference 1320 may be a difference with respect to the reception quality of the fourth beam. The reception quality difference 1320 may be an average value of the difference with respect to the reception quality of the third beam and the difference with respect to the reception quality of the fourth beam.

In this configuration, the DB updating section 620 acquires the measurement result from the measurement result acquiring section 610. The beam selecting section 630 determines the second combination and the third combination from the measurement result. Then, the DB updating section 620 updates the table 1300 corresponding to the determined second combination and third combination.

The beam selecting section 630 selects one propagation environment (i.e., the table 1300) corresponding to the present propagation environment from among the plurality of propagation environments, based on the second combination and third combination that are determined from the measurement result acquired at the present time. The beam selecting section 630 performs the selection processing using the first relationship (the reception quality difference 1320) or the second relationship (the number of reports 1330) in the selected propagation environment (the table 1300).

For example, the beam selecting section 630 performs the first selection processing as follows. The beam selecting section 630 acquires the measurement result from the measurement result acquiring section 610. The beam selecting section 630 determines the second combination and the third combination from the measurement result. It is assumed that the second combination is the combination of the beam 1 and the beam m+1, and the third combination is the combination of the radio apparatus 22-1 and the radio apparatus 22-2. In this case, the beam selecting section 630 refers to the table 1300-1 and selects the plurality of beams Bma as described above.

For example, the beam selecting section 630 performs the second selection processing as follows. An example in which the beam selecting section 630 selects the beam Bmb to be used for communication with the radio terminal 10-2 will be described. It is assumed that the radio communication apparatus 20 currently communicates with the radio terminal 10-1 using the beam 1. The beam selecting section 630 acquires the measurement result from the measurement result acquiring section 610. The beam selecting section 630 determines the second combination and the third combination from the measurement result. It is assumed that the second combination is the combination of the beam 1 and the beam m+1, and the third combination is the combination of the radio apparatus 22-1 and the radio apparatus 22-2. In this case, the beam selecting section 630 refers to the table 1300-1, and selects the beam Bmb as described above.

According to this configuration, the fourth DB 344 includes information on the first relationship and the second relationship for each second combination and for each third combination. Therefore, the fourth DB 344 reflects (includes) more propagation environments than the first DB 341. The effect of appropriately selecting the beam can be further enhanced.

In the case in which the plurality of the radio apparatuses 22-1 and 22-2 communicate with the same radio terminal 10, the beam selecting section 630 may refer to the fourth DB 344. For example, in the case in which the radio apparatus 22-1 communicates with the radio terminal 10-1 using the beam 1 and the radio apparatus 22-2 communicates with the radio terminal 10-1 using the beam m+1, the beam selecting section 630 may refer to the table 1300-1, and perform the first selection processing or the second selection processing.

There is also a beam combination which is unlikely to be the second combination. The DB updating section 620 may previously delete information corresponding to such a combination of beams from the fourth DB 344. The DB updating section 620 may delete the information corresponding to such a combination of beams according to the reception quality difference 1320 and the number of reports 1330.

In the fourth DB 344, the combination of two beams and the combination of two radio apparatuses are used, but the present disclosure is not limited to this configuration. The fourth DB 344 may be constructed to include information on the first relationship and the second relationship for each combination of three or more beams and for each combination of three or more radio apparatuses 22.

### (8) Eighth Example Alteration

The DB 340 records the number of times the measurement results are reported, but the present disclosure is not limited to this configuration. The DB 340 may record the number of times the reception quality has been measured, or the number of times the measurement has been performed but not reported to the control apparatus 21. The beam selecting section 630 may use the above pieces of information to distinguish between a beam for which the number of measurements is low and a beam that is not included in the measurement result because the reception quality is low. Therefore, the effect of properly selecting the beam can be further enhanced.

### (9) Ninth Example Alteration

The DB updating section 620 may generate the DB 340 by using machine learning. For example, clustering, which is one of unsupervised learning, may be used. The DB updating section 620 may use clustering to group measurement results that are measured under similar propagation environments, and generate information representing the first relationship or second relationship of reception quality between the beams 1 to n for each of a plurality of groups (propagation environments). The grouping may be performed based on a similarity between the measurement results. As the similarity between the measurement results, for example, an n-dimensional vector having measurement results of the beams 1 to n as elements is defined, and the cosine similarity between the vectors may be used. Alternatively, the Euclidean distance of the normalized vector may be used as the similarity between the measurement results. Further, the beam selecting section 630 may calculate a similarity between the measurement result acquired at the present time and an average measurement result of each of the plurality of groups (propagation environments), and execute the selection processing using the first relationship or the second relationship in the group (propagation environment) having the highest similarity. When obtaining the average measurement result of each of the plurality of groups (propagation environments), the measurement results may be normalized before averaging. According to this configuration, it is possible to generate the DB 340 which accurately reflects the difference in the propagation environment.

As another example of machine learning, neural networks may be used. The DB updating section 620 may use a neural network to generate a database for outputting the priority (evaluation value) of each beam in accordance with the beam combination (the first beam and the second beam) and the difference in reception quality. The measurement result of the reception quality may be used as training data for constituting the neural network. Therefore, the accuracy of the DB 340 can be expected to be improved.

### (10) Tenth Example Alteration

The control apparatus 21 may change the number of beams and the shape of the beam according to location and period of time. In the example described above, the control apparatus 21 can form beams 1 to n, but may reduce the number of beams during a period of time in which the communication traffic is small. For example, the control apparatus 21 may reduce the number of beams in a business district at night or a residential district at night. Further, the control apparatus 21 may change the shape of the beam so as to reduce the coverage area during a period of time in which the communication traffic is small. In this configuration, the control apparatus 21 may determine whether or not the communication traffic is small, based on the number of radio terminals connected to the plurality of radio apparatuses 22-1 and 22-2.

Further, the control apparatus 21 may generate the DB 340 according to location and period of time. For example, the traffic volume in business districts at night is smaller than that in business districts during the day. Therefore, it is considered that the propagation environment of the business district at night and the propagation environment of the business district at daytime are different. The control apparatus 21 may generate the first DB 341 to the fourth DB 344 to be used in a first period of time (e.g., daytime) and the first DB 341 to the fourth DB 344 to be used in a second period of time (e.g., nighttime).

### (11) Eleventh Example Alteration

The plurality of radio apparatuses 22-1 and 22-2 may communicate with the same radio terminal 10. In this case, the beam selecting section 630 may refer to two tables included in the DB 340. For example, it is assumed that the beam selecting section 630 refers to the first DB 341 in the first selection processing. The beam selecting section 630 refers to the table 700 corresponding to the beam used by the radio apparatus 22-1, and performs the first selection processing as described above. Further, the beam selecting section 630 refers to the table 700 corresponding to the beam used by the radio apparatus 22-2, and performs the first selection processing as described above. According to this configuration, the reception qualities can be measured for the beams formed by the plurality of radio apparatuses 22-1 and 22-2. As a result, the communication quality can be improved. If there is no selectable beam, the beam selecting section 630 may transmit a response indicating that the beam cannot be assigned.

In the case in which the plurality of radio apparatuses 22-1 and 22-2 communicate with the same radio terminal 10, the beam selecting section 630 may select, as the beam Bmb, a beam having the highest reception quality determined from the measurement result acquired at the present time for each of the plurality of radio apparatuses 22-1 and 22-2. That is, the beam selecting section 630 may select, as the beam Bmb, a beam having the highest reception quality among the beams 1 to m, and also select, as the beam Bmb, a beam having the highest reception quality among the beams m+1 to n.

### 3. Second Example Embodiment

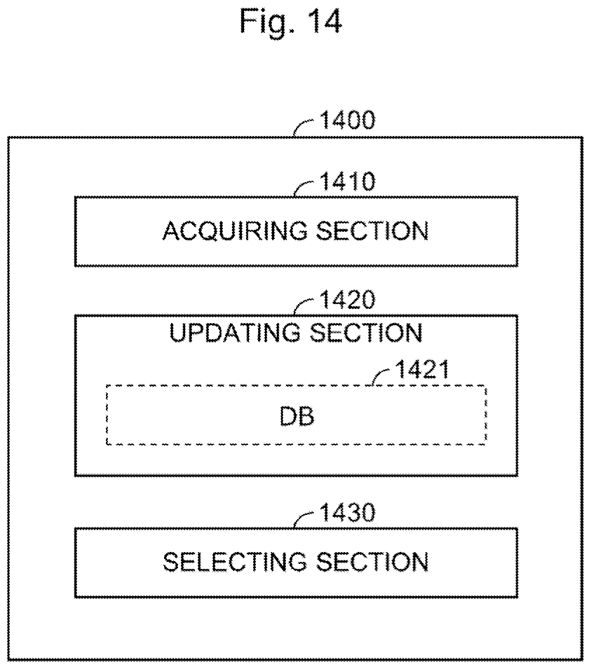

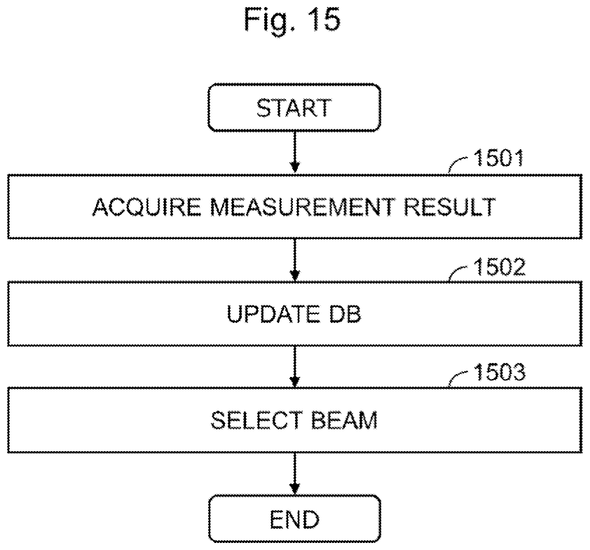

Next, with reference to FIGS. 14 and 15, a second example embodiment will be described. The above-described first example embodiment is a concrete example embodiment, whereas the second example embodiment is a more generalized example embodiment.

FIG. 14 is a diagram illustrating an example of a configuration of a control apparatus 1400. The control apparatus 1400 includes an acquiring section 1410, an updating section 1420, and a selecting section 1430.

The functional modules 1410, 1420 and 1430 included in the control apparatus 1400 may be implemented with one or both of one or more processors and a memory. The one or more processors may include, for example, one or more of a CPU, an MPU, and a micro controller. The memory may include a volatile memory and a non-volatile memory. The memory may store a program code (instructions). The one or more processors may implement the function of the control apparatus 1400 (e.g., the acquiring section 1410, the updating section 1420, and the selecting section 1430) by executing the program code stored in the memory.

The acquiring section 1410 acquires a measurement result including information on reception qualities of a plurality of beams. The updating section 1420 updates a database (DB) 1421 based on the measurement result. For example, the DB 1421 is stored in the above-described memory. The DB 1421 includes information representing a relationship between the plurality of beams for each of a plurality of propagation environments. The selecting section 1430 performs selection processing for selecting a beam using the DB 1421.

The acquiring section 1410 may operate in the same manner as the measurement result acquiring section 610. The updating section 1420 may operate in the same manner as the DB updating section 620. The DB 1421 may include at least one of the first DB 341 to the fourth DB 344 in the same manner as the DB 340 described above. The selecting section 1430 may operate in the same manner as the beam selecting section 630.

### 3-2. Flow of Processing

FIG. 15 is a diagram illustrating an example of a flow of processing of the control apparatus 1400.

The acquiring section 1410 acquires the measurement result including the information on the reception qualities of the plurality of beams (1501). The updating section 1420 updates the DB 1421 based on the measurement result (1502). The selecting section 1430 performs the selection processing for selecting a beam using the DB 1421 (1503).

According to this configuration, the control apparatus 1400 can select a beam appropriately.

### 4. Other Example Embodiments

Note that the example embodiments and the example alterations described above are merely examples, and the scope of technical ideas of the present disclosure is not limited to the configurations described above. Other example aspects conceivable within the scope of technical ideas of the present disclosure are included in the scope of the present disclosure.

The processing steps illustrated in the flowchart are not necessarily performed in the illustrated order. The processing steps may be performed in an order different from that illustrated, or two or more processing steps may be performed in parallel. Some of the processing steps may be deleted, or further processing steps may be added.

The functions of the apparatuses (the radio terminal 10, the radio communication apparatus 20, and the control apparatus 1400) described in the Specification may be implemented with one of software, hardware, and a combination of software and hardware. A program code (instructions) constituting the software may be stored in a computer readable recording medium inside or outside each of the apparatuses, for example, and when being executed, may be read in a memory to be executed by a processor. Moreover, a non-transitory computer readable recording medium having recorded thereon the program code may be provided.

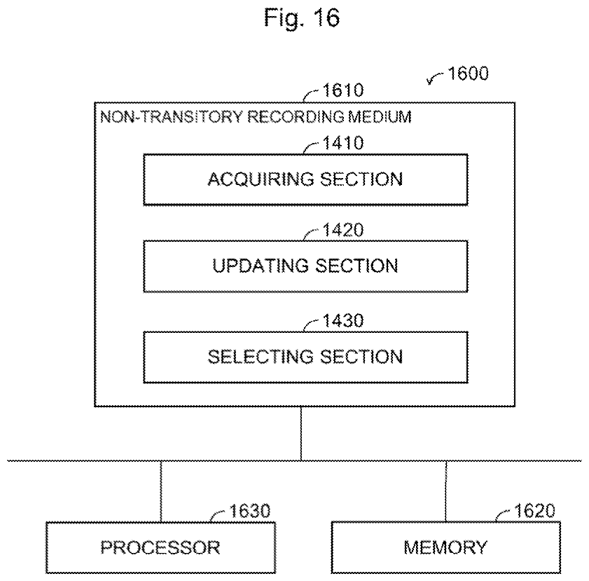

For example, FIG. 16 is a diagram illustrating an example of a combination of software and hardware for realizing the functions of the control apparatus 1400. An information processing apparatus 1600 includes a non-transitory recording medium 1610, a memory 1620, and a processor 1630. These components are connected to each other via an internal bus. The non-transitory recording medium 1610 records a program code for realizing the functional modules 1410 to 1430 of the control apparatus 1400. The program code for realizing the functional modules 1410 to 1430 is read in the memory 1620. The processor 1630 executes the processing of the functional modules 1410 to 1430 by executing the program code read into the memory 1620. Similarly, the radio terminal 10 and the radio communication apparatus 20 may be implemented by a combination of a non-transitory recording medium, a memory, and a processor.

The whole or part of the example embodiments and the example alterations described above can be described as, but not limited to, the following supplementary notes.

### Supplementary Note 1

A control apparatus including:

an acquiring section configured to acquire a measurement result including information on reception qualities of a plurality of beams;

an updating section configured to update a database including information representing a relationship between the plurality of beams for each of a plurality of propagation environments, based on the measurement result; and

a selecting section configured to perform selection processing for selecting a beam using the database.

### Supplementary Note 2

The control apparatus according to supplementary note 1, wherein the selecting section is configured to

select the relationship corresponding to a present propagation environment in the information representing the relationship, and

perform the selection processing using the selected relationship.

### Supplementary Note 3

The control apparatus according to supplementary note 2, wherein, in the information representing the relationship, the plurality of propagation environments are distinguished based on a first beam having a highest reception quality at a time point at which the measurement result is acquired, and

the selecting section is configured to regard a beam currently in use or to be used next as the first beam, and select the relationship corresponding to the present propagation environment.

### Supplementary Note 4

The control apparatus according to supplementary note 2, wherein, in the information representing the relationship, the plurality of propagation environments are distinguished based on a first beam having a highest reception quality at a time point at which the measurement result is acquired, and the reception quality of the first beam, and

the selecting section is configured to select the relationship corresponding to the present propagation environment, based on the first beam determined from the measurement result acquired at a present time, and the reception quality of the first beam.

### Supplementary Note 5

The control apparatus according to supplementary note 2, wherein, in the information representing the relationship, the plurality of propagation environments are distinguished based on a first combination of beams,

the first combination includes at least a first beam having a highest reception quality at a time point at which the measurement result is acquired, and a second beam having a second highest reception quality at the time point at which the measurement result is acquired, and

the selecting section is configured to select the relationship corresponding to the present propagation environment, based on the first combination determined from the measurement result acquired at a present time.

### Supplementary Note 6

The control apparatus according to supplementary note 2, wherein the control apparatus is connected to a plurality of radio apparatuses forming the plurality of beams, and is configured to communicate with a plurality of radio terminals via the plurality of radio apparatuses,

in the information representing the relationship, the plurality of propagation environments are distinguished based on a second combination of beams and a third combination of radio apparatuses,

the third combination includes at least
a first radio apparatus included in the plurality of radio apparatuses and forming a third beam having a highest reception quality in a first beam set; and
a second radio apparatus included in the plurality of radio apparatuses and forming a fourth beam having a highest reception quality in a second beam set,

the first beam set is a set of all beams included in the measurement result,

the second beam set is a set in which beams formed by the first radio apparatus are deleted from the first beam set,

the second combination includes at least the third beam and the fourth beam, and

the selecting section is configured to select the relationship corresponding to the present propagation environment, based on the second combination and the third combination that are determined from the measurement result acquired at a present time.

### Supplementary Note 7

The control apparatus according to supplementary note 2, wherein, in the information representing the relationship, the plurality of propagation environments are distinguished based on a similarity of the measurement result, and

the selecting section is configured to select the relationship corresponding to the present propagation environment, based on the similarity between the measurement result acquired at a present time, and an average measurement result of each of the plurality of propagation environments.

### Supplementary Note 8

The control apparatus according to supplementary note 7, wherein the similarity includes a cosine similarity between vectors, the vector having the reception qualities of the plurality of beams as elements.

### Supplementary Note 9

The control apparatus according to any one of supplementary notes 1 to 8, wherein the information representing the relationship includes first information representing a first relationship of a difference in the reception quality between the plurality of beams.

### Supplementary Note 10

The control apparatus according to supplementary note 9, wherein the control apparatus is connected to a plurality of radio apparatuses forming the plurality of beams, and is configured to communicate with a plurality of radio terminals via the plurality of radio apparatuses,

the selecting section is configured to
select the first relationship corresponding to the present propagation environment in the first information, and
perform the selection processing using the selected first relationship, and

the selection processing includes one or both of
first selection processing for selecting a beam to be used for measuring the reception quality, and
second selection processing for selecting a beam to be used for communication with the radio terminal.

### Supplementary Note 11

The control apparatus according to supplementary note 10, wherein the first selection processing includes selecting a predetermined number of beams in ascending order of the difference with respect to a beam currently in use or a beam to be used next.

### Supplementary Note 12

The control apparatus according to supplementary note 11, wherein the first selection processing includes selecting the predetermined number of beams such that the predetermined number of beams include a plurality of beams corresponding to two or more radio apparatuses among the plurality of radio apparatuses.

### Supplementary Note 13

The control apparatus according to supplementary note 10, wherein, in a case in which the control apparatus communicates with the plurality of radio terminals, the second selection processing includes selecting a beam for which the difference with respect to a beam currently in use is greater than a predetermined first threshold.

### Supplementary Note 14

The control apparatus according to supplementary note 10, wherein, in a case in which the control apparatus communicates with a same radio terminal via the plurality of radio apparatuses, the second selection processing includes selecting a beam having a highest reception quality determined from the measurement result acquired at a present time in each of the plurality of radio apparatuses.

### Supplementary Note 15

The control apparatus according to any one of supplementary notes 1 to 8, wherein the information representing the relationship includes second information representing a second relationship of a number of reports about the reception quality between the plurality of beams.

### Supplementary Note 16

The control apparatus according to supplementary note 15, wherein the control apparatus is connected to a plurality of radio apparatuses forming the plurality of beams, and is configured to communicate with a plurality of radio terminals via the plurality of radio apparatuses,

the selecting section is configured to
select the second relationship corresponding to the present propagation environment in the second information, and
perform the selection processing using the selected second relationship, and

the selection processing includes one or both of
first selection processing for selecting a beam to be used for measuring the reception quality, and
second selection processing for selecting a beam to be used for communication with the radio terminal.

### Supplementary Note 17

The control apparatus according to supplementary note 16, wherein the first selection processing includes selecting a predetermined number of beams in descending order of the number of reports.

### Supplementary Note 18

The control apparatus according to supplementary note 16, wherein the second selection processing includes selecting a beam for which the number of reports is less than a predetermined second threshold.

### Supplementary Note 19

The control apparatus according to any one of supplementary notes 1 to 18, wherein the updating section is configured to select a beam for updating the database.

### Supplementary Note 20

The control apparatus according to supplementary note 19, wherein the control apparatus is connected to a plurality of radio apparatuses forming the plurality of beams, and is configured to communicate with a plurality of radio terminals via the plurality of radio apparatuses, and

the updating section is configured to transmit instruction information for instructing the radio terminal about the reception quality of the beam to be included in the measurement result.

### Supplementary Note 21

The control apparatus according to supplementary note 20, wherein the updating section is configured to transmit the instruction information such that reception qualities of beams corresponding to two or more radio apparatuses among the plurality of radio apparatuses are included in the measurement result.

### Supplementary Note 22

The control apparatus according to supplementary note 20, wherein the updating section is configured to generate the database to be used in a first period of time and the database to be used in a second period of time.

### Supplementary Note 23

A control method including:

acquiring a measurement result including information on reception qualities of a plurality of beams,

updating a database including information representing a relationship between the plurality of beams for each of a plurality of propagation environments, based on the measurement result, and

performing selection processing for selecting a beam using the database.

### Supplementary Note 24

A program causing a computer including a processor and a memory to execute:

acquiring a measurement result including information on reception qualities of a plurality of beams,

updating a database including information representing a relationship between the plurality of beams for each of a plurality of propagation environments, based on the measurement result, and

performing selection processing for selecting a beam using the database.

What is claimed is:

1. A control apparatus comprising:
one or more memories configured to store instructions; and
one or more processors configured to execute the instructions to
acquire a measurement result including information on reception qualities of a plurality of beams;
update a database including information representing a relationship between the plurality of beams for each of a plurality of propagation environments, based on the measurement result; and
perform selection processing for selecting a beam using the database.

2. The control apparatus according to claim 1, wherein the one or more processors are configured to
select the relationship corresponding to a present propagation environment in the information representing the relationship, and
perform the selection processing using the selected relationship.

3. The control apparatus according to claim 2, wherein, in the information representing the relationship, the plurality of propagation environments are distinguished based on a first beam having a highest reception quality at a time point at which the measurement result is acquired, and
the one or more processors are configured to regard a beam currently in use or to be used next as the first beam, and select the relationship corresponding to the present propagation environment.

4. The control apparatus according to claim 2, wherein, in the information representing the relationship, the plurality of propagation environments are distinguished based on a first beam having a highest reception quality at a time point at which the measurement result is acquired, and the reception quality of the first beam, and
the one or more processors are configured to select the relationship corresponding to the present propagation environment, based on the first beam determined from the measurement result acquired at a present time, and the reception quality of the first beam.

5. The control apparatus according to claim 2, wherein, in the information representing the relationship, the plurality of propagation environments are distinguished based on a first combination of beams,
the first combination includes at least a first beam having a highest reception quality at a time point at which the measurement result is acquired, and a second beam having a second highest reception quality at the time point at which the measurement result is acquired, and
the one or more processors are configured to select the relationship corresponding to the present propagation environment, based on the first combination determined from the measurement result acquired at a present time.

6. The control apparatus according to claim 2, wherein the control apparatus is connected to a plurality of radio apparatuses forming the plurality of beams, and is configured to communicate with a plurality of radio terminals via the plurality of radio apparatuses,
in the information representing the relationship, the plurality of propagation environments are distinguished based on a second combination of beams and a third combination of radio apparatuses,
the third combination includes at least
a first radio apparatus included in the plurality of radio apparatuses and forming a third beam having a highest reception quality in a first beam set; and
a second radio apparatus included in the plurality of radio apparatuses and forming a fourth beam having a highest reception quality in a second beam set,
the first beam set is a set of all beams included in the measurement result,
the second beam set is a set in which beams formed by the first radio apparatus are deleted from the first beam set,
the second combination includes at least the third beam and the fourth beam, and
the one or more processors are configured to select the relationship corresponding to the present propagation environment, based on the second combination and the third combination that are determined from the measurement result acquired at a present time.

7. The control apparatus according to claim 2, wherein, in the information representing the relationship, the plurality of propagation environments are distinguished based on a similarity of the measurement result, and
the one or more processors are configured to select the relationship corresponding to the present propagation environment, based on the similarity between the measurement result acquired at a present time, and an average measurement result of each of the plurality of propagation environments.

8. The control apparatus according to claim 1, wherein the information representing the relationship includes first information representing a first relationship of a difference in the reception quality between the plurality of beams.

9. The control apparatus according to claim 8, wherein the control apparatus is connected to a plurality of radio apparatuses forming the plurality of beams, and is configured to communicate with a plurality of radio terminals via the plurality of radio apparatuses,
the one or more processors are configured to
select the first relationship corresponding to the present propagation environment in the first information, and
perform the selection processing using the selected first relationship, and
the selection processing includes one or both of
first selection processing for selecting a beam to be used for measuring the reception quality, and
second selection processing for selecting a beam to be used for communication with the radio terminal.

10. The control apparatus according to claim 9, wherein the first selection processing includes selecting a predetermined number of beams in ascending order of the difference with respect to a beam currently in use or a beam to be used next.

11. The control apparatus according to claim 9, wherein, in a case in which the control apparatus communicates with the plurality of radio terminals, the second selection processing includes selecting a beam for which the difference with respect to a beam currently in use is greater than a predetermined first threshold.

12. The control apparatus according to claim 9, wherein, in a case in which the control apparatus communicates with a same radio terminal via the plurality of radio apparatuses, the second selection processing includes selecting a beam having a highest reception quality determined from the measurement result acquired at a present time in each of the plurality of radio apparatuses.

13. The control apparatus according to claim 1, wherein the information representing the relationship includes second information representing a second relationship of a number of reports about the reception quality between the plurality of beams.

14. The control apparatus according to claim 13, wherein the control apparatus is connected to a plurality of radio apparatuses forming the plurality of beams, and is configured to communicate with a plurality of radio terminals via the plurality of radio apparatuses,
the one or more processors are configured to
select the second relationship corresponding to the present propagation environment in the second information, and
perform the selection processing using the selected second relationship, and
the selection processing includes one or both of
first selection processing for selecting a beam to be used for measuring the reception quality, and
second selection processing for selecting a beam to be used for communication with the radio terminal.

15. The control apparatus according to claim 1, wherein the one or more processors are configured to select a beam for updating the database.

16. The control apparatus according to claim 15, wherein the control apparatus is connected to a plurality of radio apparatuses forming the plurality of beams, and is configured to communicate with a plurality of radio terminals via the plurality of radio apparatuses, and
the one or more processors are configured to transmit instruction information for instructing the radio terminal about the reception quality of the beam to be included in the measurement result.

17. The control apparatus according to claim 16, wherein the one or more processors are configured to transmit the instruction information such that reception qualities of beams corresponding to two or more radio apparatuses among the plurality of radio apparatuses are included in the measurement result.

18. The control apparatus according to claim 16, wherein the one or more processors are configured to generate the database to be used in a first period of time and the database to be used in a second period of time.

19. A control method comprising:
acquiring a measurement result including information on reception qualities of a plurality of beams,
updating a database including information representing a relationship between the plurality of beams for each of a plurality of propagation environments, based on the measurement result, and
performing selection processing for selecting a beam using the database.

20. A non-transitory computer readable recording medium storing a program causing a computer including a processor and a memory to execute:
acquiring a measurement result including information on reception qualities of a plurality of beams,
updating a database including information representing a relationship between the plurality of beams for each of a plurality of propagation environments, based on the measurement result, and
performing selection processing for selecting a beam using the database.
